(19) United States
(12) Patent Application Publication
(10) Pub. No.: US 2006/0224518 A1
(43) Pub. Date: Oct. 5, 2006

(54) Partial credential processing for limited commerce interactions

(75) Inventors: Darshanand Khusial, Mississauga (CA); Mark A. McKelvey, Seattle, WA (US); Remedios R. Nisbet, Irvington, NY (US); Victoria Wong, North Vancouver (CA)

Correspondence Address: International Business Machines;Intellectual Property Law, T81/503, 3039 Cornwallis Road, P.O. Box 12195, Research Triangle Park, NC, 27709, US

(73) Assignee: INTERNATIONAL BUSINESS MACHINES CORPORATION, ARMONK, NY (US)

(21) Appl. No.: 11/099,246

(22) Filed: Apr. 5, 2005

(51) Int. Cl. G06F 17/60

(52) U.S. Cl. 705/52

(57) ABSTRACT

A method, system and apparatus for partial credential processing for limited commerce system interactions. The method can include identifying a visitor to a commerce system as an unauthenticated albeit registered user of the commerce system. Subsequently, the visitor can be provided access to a limited subset of commerce data for the registered user under an un-trusted identity. In the course of the visitor interacting with the commerce system, additional commerce data, such as shopping cart data, can be generated under the un-trusted identity until the visitor authenticates with the commerce system. When the visitor authenticates with the commerce system, a full set of the commerce data for the registered user under a trusted identity can be provided. Additionally, the generated additional commerce data can be merged under the un-trusted identity with the commerce data for the registered user under the trusted identity.

### BACKGROUND OF THE INVENTION

1. Statement of the Technical Field

The present invention relates to the field of electronic commerce systems and more particularly to user authentication in an electronic commerce system.

2. Description of the Related Art

In many electronic commerce (e-commerce) applications, users first must authenticate with the application before the user can interact with the e-commerce system. While a successful authentication can ensure the integrity for interactions such as the retrieval of a user profile and the manipulation of order data associated with the identity of the user, requiring the user to undertake an authentication process each time the user desires to interact with the e-commerce system can become an inconvenience to the user. Rather, most registered users of an e-commerce application prefer to interact with the e-commerce system without engaging in an authentication process and are willing to do so only at the time of purchasing goods or services in the system.

A number of e-commerce systems permit registered users to interact with the e-commerce system without authenticating first. To enable such functionality, a temporary identity can be provided to users to permit the users to interact with the e-commerce. Put plainly users can shop an online store without first logging in. However, when a user ultimately authenticates to the e-commerce system, the resources bound to the temporary identity can be merged into that of the registered identity of the user.

The disadvantage of the foregoing arrangement, though, is that the arrangement permits user interactions with the e-commerce system while in an unauthenticated mode. Although able to interact with the e-commerce system, the user cannot see or access historical interactions previously bound to same user's authenticated identity. Furthermore, the e-commerce system cannot recognize the user in an unauthenticated mode to provide personalized interactions with the user.

To avoid the hassle of requiring each user to repeatedly authenticate when interacting with the e-commerce system, a user can be automatically authenticated to an e-commerce system through the operation of a persistent cookie stored with the user. The presence of the persistent cookie can ensure the user that the user need not authenticate for each new session with the e-commerce system in order to execute operations under the registered identity of the user. Still, as the skilled artisan will recognize, the use of a persistent cookie can have serious security implications.

Specifically, the use of a persistent cookie necessarily can result in the presence of a trail on the user's file system indicating the historical transactions with the e-commerce system conducted at the behest of the user. Yet, persistent cookies can be susceptible to theft in consequence of which a malicious third-party can utilize a stolen persistent cookie to obtain entry into an e-commerce system masquerading as the authorized user. Hence it remains a more desirable scenario to use temporary cookies in lieu of persistent cookies to hold the full credentials of a user since temporary cookies are stored in memory and destroyed at the conclusion of a browsing session.

### SUMMARY OF THE INVENTION

The present invention addresses the deficiencies of the art in respect to user authentication in a commerce system and provides a novel and non-obvious method, system and apparatus for partial credential processing for limited commerce system interactions. A method for partial credential processing for limited commerce system interactions can include identifying a visitor to a commerce system as an unauthenticated albeit registered user of the commerce system. Subsequently, the visitor can be provided access to a limited subset of commerce data for the registered user under an un-trusted identity. Consequently, the commerce system can be personalized for the benefit of the visitor using the limited subset of commerce data.

In the course of the visitor interacting with the commerce system, additional commerce data, such as shopping cart data, can be generated under the un-trusted identity until the visitor authenticates with the commerce system. When the visitor authenticates with the commerce system, a full set of the commerce data for the registered user under a trusted identity can be provided. Additionally, the generated additional commerce data can be merged under the un-trusted identity with the commerce data for the registered user under the trusted identity. Finally, the personalization of the commerce system can incorporate the entirety of the commerce data.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a commerce system configured for partial credential processing for limited commerce system interactions; and,

FIGS. 2A through 2D, taken together, are a flow chart illustrating a process for partial credential processing for limited commerce system interactions.

### DETAILED DESCRIPTION OF THE PREFERRED EMBODIMENTS

The present invention is a method, system and apparatus for partial credential processing for limited commerce system interactions. In accordance with the present invention, a visitor to a commerce system can be classified as a guest or a registered user, regardless of whether the visitor has authenticated into the commerce system. As a guest, the visitor can be assigned an un-trusted identity and the visitor can interact with the commerce system allowing the commerce system to have the benefit of a partial set of stored knowledge associated with the visitor. In this way, the visitor need not undertake an authentication process prior to interacting with the commerce system. In contrast, as an authenticated, registered user, the visitor can enjoy the benefit of a full set of pre-stored knowledge regarding prior interactions with the commerce system.

Importantly, to facilitate partial credential processing for limited commerce system interactions, a set of temporary and permanent records can be maintained in the host computing platform for the visitor. As an example, the temporary and permanent records can be browser cookies, both temporary and permanent. In the present invention, once a visitor has interacted with the commerce system, a set of partial credentials can be stored in a permanent record in the host computing platform. The partial credentials can identify the visitor as a guest to the system so that the commerce system can determine subsequently that the visitor had previously interacted with the commerce system. Once the visitor has registered with the commerce system, the partial credentials can be changed to identify the visitor as a registered user.

Notably, a full set of credentials can be issued to a visitor, irrespective of whether the visitor is a registered user or a guest user of the commerce system. The full set of credentials can be used to provide a personalization of the interactions between the visitor and the commerce system. Where the visitor authenticates to the commerce system, the full set of credentials can include secure information required to more fully interact with the commerce system. Regardless, the temporary record can be placed into the host computing platform; however, at the conclusion of those interactions the temporary record can be destroyed leaving only the permanent record containing the partial set of credentials.

To support the personalization of interactions with a visitor to the commerce system, a subset of previously stored commerce data for the visitor can be selected by the server for use by the visitor under an un-trusted identity. Specifically, when a previous visitor to the commerce system returns for a new visit, the server selectively copies data from the previously registered identity, identified by the permanent record, to a temporary un-trusted identity. Changes, deletions or additions to the subset of commerce data can remain separate from the remainder of the stored commerce data. Moreover, until authenticated, a visitor can be limited in its ability to change the commerce data. Once the visitor authenticates with the commerce system and obtains a trusted identity; however, the subset of commerce data can be merged with the previously stored commerce data for the trusted identity.

The skilled artisan will recognize the uniqueness of the inventive arrangements in that two separate identities; each having a different level of trust, can be assigned to a visitor. Data associated with the more trusted identity can be selectively copied to the less trusted identity. A visitor to the commerce system, acting under the less trusted identity, may be able to view and modify data associated with the more trusted identity. Notwithstanding, when the visitor interacts with the commerce system under the less trusted identity, the data associated with the less trusted identity is not merged with the data of the more trusted identity unless the visitor, operating under the less trusted identity, authenticates to the system.

The advantages of the present invention will be apparent to the skilled artisan:

i) The credentials for the trusted identity are not permanently stored in the host platform. Consequently, a rogue user cannot locate and replay the credentials through a scouring of the file system for the host platform.

ii) Only selected resources of the commerce system which are associated with a registered identity can be modified by an unauthenticated visitor.

iii) Operations performed on resources in the commerce system which are owned by the registered identity, while the customer is unauthenticated, are reflected back into the registered identity only after the customer successfully authenticates.

iv) Data associated with the registered identity can be used to provide personalization for an unauthenticated user.

v) The control logic which selects data to be copied from the registered identity into the temporary identity resides within the commerce system and not within the host platform of the visitor. Hence, a rogue client cannot choose to copy unauthorized information from the registered identity into the temporary identity.

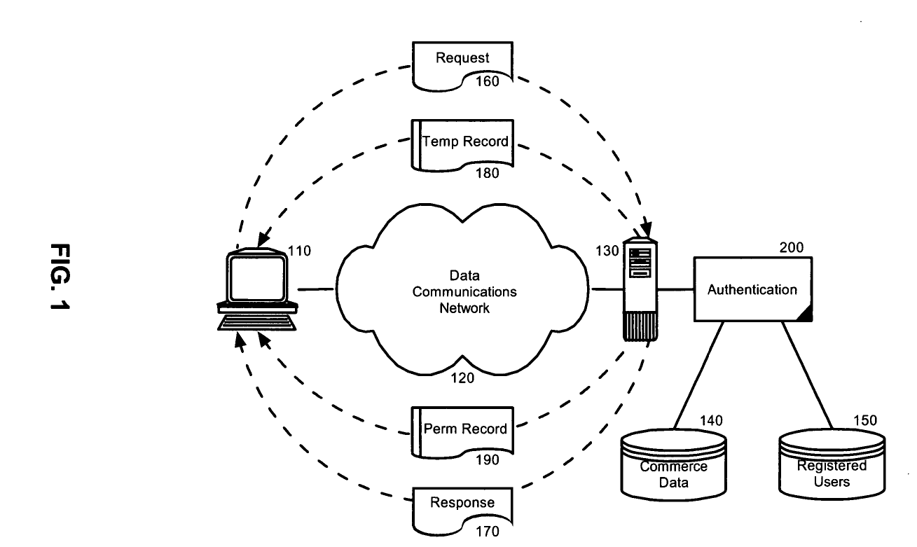

In further illustration of a preferred aspect of the present invention, FIG. 1 is a schematic illustration of a commerce system configured for partial credential processing for limited commerce system interactions. The system can include a commerce server 130 coupled to one or more client host computing platforms 110 over a data communications network 120, including for example, the global Internet. The commerce server 130 can host a commerce application, such as a series of statically maintained and dynamically produced markup pages coupled to back end logic for processing commerce interactions with clients. In this regard, the commerce server 130 can be configured to process requests 160 from one or more users interacting with the commerce server 130 over the data communications network 120 in order to produce responses 170 to those requests 160.

Notably, an authentication process 200 can be coupled to the commerce server 130. The authentication process 200 can include logic for performing partial credential processing for limited interactions with the commerce server 130. Specifically, the authentication process 200 can manage the generation and placement of temporary records 180 and permanent records 190 in the host client computing platform 110 for a user interacting with the commerce server 130. The content of the permanent records 190 and the temporary records 180 can be determined based upon whether the visitor associated with the host client computing platform 110 has a trusted identity or an un-trusted identity.

More specifically, when a visitor transmits a request 160 to the commerce server, client host computing platform 110 can be inspected for a permanent record 190 which indicates partial credentials for the visitor. The authentication process 200 can locate with the data store of registered users 150 a registered user corresponding to the partial credentials. Otherwise, the visitor can be presumed to be a guest user. Once the visitor has been determined to be a registered user or a guest, corresponding full credential information disposed within a data store of registered users 150 can be written to a temporary record 180. Finally, when the visitor discontinues interactions with the commerce server 130, the temporary record 180 containing the full credential information can be destroyed.

Importantly, a data store of commerce data 140 can be coupled to the commerce server 130 and to the authentication process 200. The commerce data 140 can include both confidential data regarding visitor-commerce system interactions and non-confidential data regarding visitor-commerce system interactions. Examples can include a shopping cart and credit card information. Notably, the behavior and user interface of the commerce system can be personalized for the benefit of a visitor based upon the subset of the commerce data 140 which can be accessed prior to the authentication of the visitor. Yet, confidential portions of the commerce data 140 can remain inaccessible from the visitor until the visitor authenticates.

Preferably, a logical shopping cart can be maintained as part of the commerce data 140 for each visitor. The logical shopping can include a shopping cart for an un-trusted identity for a visitor and a corresponding shopping cart for a trusted identity for the visitor. Shopping cart data can be accumulated for a visitor prior to authentication in the shopping cart for an un-trusted identity for the visitor. Once authenticated, the shopping cart data which had been accumulated in the un-trusted identity portion of the shopping cart can be merged into the trusted portion and shopping cart data can be accumulated in the trusted portion while the visitor remains authenticated.

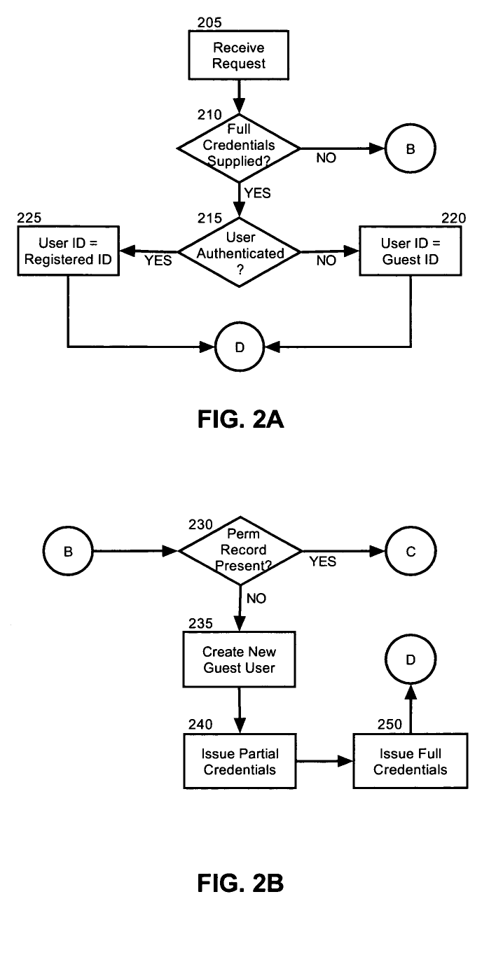

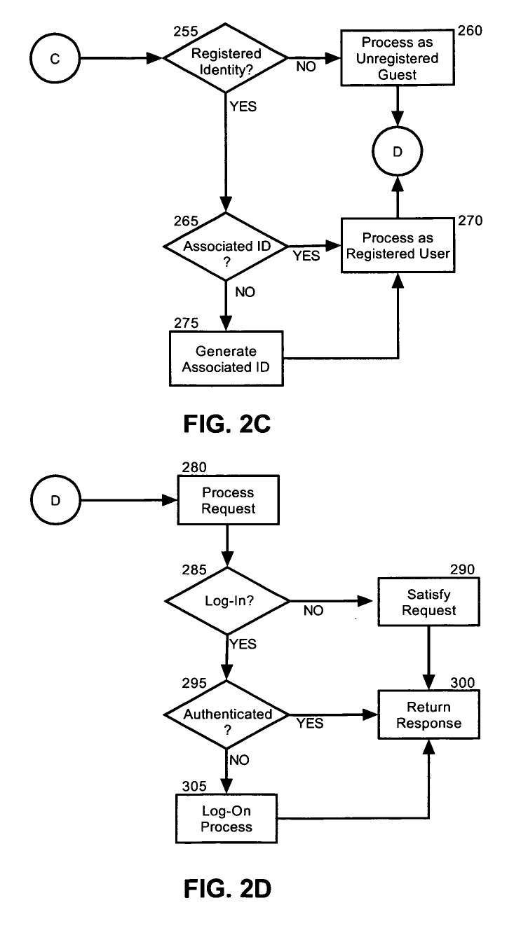

In more particular illustration of the operation of the authentication process 200, FIGS. 2A through 2D, taken together, are a flow chart illustrating a process for partial credential processing for limited commerce system interactions. Referring first to FIG. 2A, in block 205 a request can be received from a visitor to the commerce system. In decision block 210, it can be determined whether a temporary record in the host computing platform of the visitor includes full credentials of either a guest or registered user. If so, in block 215 it further can be determined whether the visitor already has authenticated with the commerce system for the current session. If so, in block 225 the user identifier can be equated to the registered identifier for the visitor. Otherwise, in block 220 the user identifier can be equated to a guest identifier for the visitor.

Referring now to FIG. 2B, if in decision block 210 of FIG. 2A the full credentials of the visitor have not been supplied, leading through jump circle B it can be determined in decision block 230 whether partial credentials are present in a permanent record disposed in the host computing platform of the visitor indicating that the visitor had previously visited the commerce system. If not, it is presumed that the visitor had not previously visited the commerce system.

Consequently, in block 235, a new guest user record can be created for the visitor. The guest user record can include commerce data such as a shopping cart. Also, in block 240 partial credentials for the visitor can be disposed in a permanent record in the host computing platform of the visitor indicating the visitor has now visited the commerce system. Moreover, full credentials designating the visitor as a guest user can be issued in a temporary record disposed in the host computing platform in block 250.

Referring now to FIG. 2C, if partial credentials are located within a permanent record in the host computing platform of the visitor in decision block 230 of FIG. 2B, indicating that the visitor had previously interacted with the commerce system, leading through jump circle C in decision block 255, the partial credentials can be compared to an existing set of guest users to determine whether the visitor is a guest user for the present session. If so, in block 260 the visitor will be designated a guest user and any secure information can be removed from the temporary record in the host computing platform of the visitor.

By comparison, based upon the partial credentials, in decision block 255 if it is determined that the visitor is a previously registered user, in block 265 it will be further determined whether the visitor enjoys an associated temporary user identifier which is linked to the identity in the partial credentials. If not, a user identifier can be generated for the visitor and resources associated with the identity of the partial credentials selectively copied to newly generated identity in block 275. Subsequently, in block 270 the visitor newly generated identity can be treated as a registered user and the full credentials of the newly generated identity for the user can be placed within a temporary record in the host computing platform of the visitor.

Referring now to FIG. 2D, once the credentialing process has completed, in block 280, the received request from the visitor can be processed to determine the nature of the request. In decision block 285, it can be determined whether the request is a request to authenticate into the commerce system. If not, in block 290, the request can be satisfied by the commerce system utilizing the existing full credentials for the visitor and in block 300 a response to the request can be returned to the visitor. Otherwise, in decision block 295, if it is determined that the visitor has not already authenticated, in block 305 the visitor can engage in an authentication process before returning a response to the visitor in block 300.

Specifically, the authentication process can include deleting the content or the entirety of the permanent record holding the partial credentials of the unauthenticated visitor. Subsequently, the partial credentials of an authenticated visitor can be placed in a permanent record in the host computing platform of the visitor. Finally, commerce data for the unauthenticated visitor, for instance a shopping cart, can be re-designated as or copied into the commerce data for the authenticated visitor and, if need be, the original commerce data for the unauthenticated visitor can be removed.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. A method for partial credential processing for limited commerce system interactions comprising the steps of:
identifying a visitor to a commerce system as an unauthenticated albeit registered user of said commerce system;
providing said visitor access to a limited subset of commerce data for said registered user under an un-trusted identity;
generating additional commerce data under said un-trusted identity; and,
responsive to authenticating said visitor, providing a full set of said commerce data for said registered user under a trusted identity and merging said generated additional commerce data under said un-trusted identity with said commerce data for said registered user under said trusted identity.

2. The method of claim 1, wherein said identifying step comprises the steps of:
locating a permanent record disposed in a host computing platform for said visitor;
retrieving from said permanent record a set of partial credentials for an un-trusted identity; and,
associating said un-trusted identity with said trusted identity in said commerce system.

3. The method of claim 1, wherein said providing step comprises the step of selectively copying data from said trusted identity to an un-trusted identity prior to a visitor authenticating with said commerce system

4. The method of claim 2, further comprising the step of, responsive to said authenticating said visitor, writing a temporary record to said host computing platform and storing full credential information for said visitor in said temporary record.

5. The method of claim 2, wherein said permanent record is a permanent cookie.

6. The method of claim 4, wherein said temporary record is a temporary cookie.

7. The method of claim 4, further comprising the step of destroying said temporary record when terminating interactions between said visitor and said commerce system.

8. The method of claim 1, wherein said generating step comprises the step of populating a shopping cart with selected items for purchase through said commerce system.

9. The method of claim 8 wherein said merging step comprises the steps of:
merging a shopping cart for said un-trusted identity with a shopping cart for said trusted identity; and,
destroying said shopping cart for said un-trusted identity.

10. The method of claim 1, further comprising the step of personalizing said commerce system for said visitor prior to said authenticating step utilizing said limited subset of commerce data.

11. A commerce system configured for partial credential processing for limited commerce system interactions comprising:
a commerce server;
a data store of registered users;
a data store of commerce data for said registered users; and,
an authentication processor configured to
identify a visitor to the commerce system as an unauthenticated albeit registered user of the commerce system;
provide said visitor access to a limited subset of said commerce data under an un-trusted identity;
generate additional commerce data for said registered user under said un-trusted identity; and,
responsive to an authentication of said visitor,
provide a full set of said commerce data for said registered user under a trusted identity, and
merging said generated additional commerce data under said un-trusted identity with said commerce data for said registered user under said trusted identity.

12. The system of claim 11, wherein said commerce data comprises a logical shopping cart bifurcated into a shopping cart for an un-trusted identity of a visitor and a shopping cart for a trusted identity of said visitor.

13. A computer program product comprising a computer usable medium embodying program instructions for partial credential processing for limited commerce system interactions, wherein the program instructions when executed by a computer cause the computer to:
identify a visitor to a commerce system as an unauthenticated albeit registered user of said commerce system;
provide said visitor access to a limited subset of commerce data for said registered user under an un-trusted identity;
generate additional commerce data under said un-trusted identity; and,
respond to authentication of said visitor by providing a full set of said commerce data for said registered user under a trusted identity and to merge said generated additional commerce data under said un-trusted identity with said commerce data for said registered user under said trusted identity.

14. The computer program product of claim 13, including further program instructions which, responsive to identification of the visitor, causes the computer to:
locate a permanent record disposed in a host computing platform for said visitor;
retrieve from said permanent record a set of partial credentials for an un-trusted identity; and,
associate said un-trusted identity with said trusted identity in said commerce system.

15. The computer program product of claim 14, wherein said program instructions that cause the visitor to be provided access further cause the computer to selectively copy data from said trusted identity to an un-trusted identity prior to a visitor being authenticated with said commerce system

16. The computer program product of claim 14, further including program instructions that cause the computer, responsive to authentication of said visitor, to write a temporary record to said host computing platform and to store full credential information for said visitor in said temporary record.

17. The computer program product of claim 14, wherein said permanent record is a permanent cookie.

18. The computer program product of claim 16, wherein said temporary record is a temporary cookie.

19. The computer program product of claim 16, further including program instructions that, when executed, cause the computer to destroy said temporary record when terminating interactions between said visitor and said commerce system.

20. The computer program product of claim 13, wherein the computer, when generating additional commerce data, populates a shopping cart with selected items for purchase through said commerce system.

21. The computer program product of claim 20, wherein the computer, when destroying said temporary record, merges a shopping cart for said un-trusted identity with a shopping cart for said trusted identity; and, destroys said shopping cart for said un-trusted identity.

22. The computer program product of claim 13, further comprising program instructions which, when executed, cause the computer to personalize said commerce system for said visitor utilizing said limited subset of commerce data provided prior to the visitor being authenticated with the system.
